(19) United States
(12) Patent Application Publication
(10) Pub. No.: US 2005/0150662 A1
(43) Pub. Date: Jul. 14, 2005

(54) Fire protection sprinkler system

(76) Inventor: Teddy G. Bochan, Lethbridge (CA)

Correspondence Address: Ralph A. Dowell of DOWELL & DOWELL P.C., 2111 Eisenhower Ave., Suite 406, Alexandria, VA, 22314, US

(21) Appl. No.: 10/754,668

(22) Filed: Jan. 12, 2004

(51) Int. Cl. A62C 35/00

(52) U.S. Cl. 169/16

(57) ABSTRACT

A portable, inexpensive, and easily installed fire protection sprinkler system for protection of objects against encroaching outdoor fires is provided. The system comprises a flexible hose to which is attached two pipes. Sprinkler heads are mounted to the ends of the two pipes, and a water hose is attached to one of the pipes. The flexible hose allows the pipes to be placed at angles to each other as would be necessary, for example, if the sprinkler system is placed over a peaked roof.

### FIELD OF THE INVENTION

The invention relates to fire protection sprinkler systems and in particular to sprinkler systems used to protect structures and other objects from forest fires and other outdoor fires.

### BACKGROUND OF THE INVENTION

The threat of forest fires and other fires destroying structures and other objects has existed for a long period of time. However, as urban density has increased, as urban developments have reached further into forests, and as commercial enterprises such as logging, oil and gas exploration, etc. have moved further into the wilderness, the protection of homes, sheds, bridges, wood piles and other objects against forest fires, wildfires, and other outdoor fires has become increasingly important.

One method of protecting such objects against outdoor fires is to spray the object, and in particular the top surface thereof (typically the roof) with water. The spray of water resists fire ignition by cooling the object, and by wetting it. At present, there are two systems commonly used for spraying such objects.

In the first system, an impulse-type sprinkler (for example those sold under the trade-mark RAINBIRD) is affixed to a post, which is in turn affixed to the eaves of the roof. A hose is then connected to the sprinkler and to a water source. The water source may be a municipal water system, or more commonly if the structure is in a rural area, a pump drawing water from a pond, lagoon or lake.

There are many problems with such a system. First, the system is not structurally stable. Owing to the action of the impulse-type sprinkler, the sprinkler vibrates when the sprinkler operates, which vibrations are carried through to the post. The vibration of the post in turn tends to work the post loose from the eaves of the roof of the building resulting in failure. Second, impulse-type sprinklers typically have small spray orifices. Because the water being used for spraying is often drawn from a pond, lagoon or lake, particulate matter can easily clog the orifices of the sprinkler again resulting in failure, or at least compromised performance. Third, because the post must be affixed to the eaves of the roof, the system is not easily portable. Fourth, affixing the post to the eaves of the roof can result in undesirable damage to the roof, whether structurally, aesthetically or both. Fifth, because the sprinkler is affixed at the edge of the roof, full spray coverage of the roof is difficult. Sixth, installation of the system can be challenging and dangerous. Affixing the post to the roof will typically require the use of a ladder and the possible awkward handling of the post and sprinkler. This is a particularly important disadvantage to many contractors since in many jurisdictions, employees who are required to use ladders in the performance of their jobs must have undergone ladder training. Finally, where the roof is pitched it is necessary for the angle at which the sprinkler is mounted to be adjusted so as to increase coverage.

The second system is very similar to the first system except that pop-up style garden sprinklers are affixed directly to the eaves of the roof without the use of a post. This system presents almost all of the same problems as the first system except this system is even less portable and more difficult to install and maintain since a greater number of sprinklers will typically be required.

There is therefore a need for a fire protection sprinkler system which alleviates one or more of the above problems.

### SUMMARY OF THE INVENTION

The present invention provides a simple, easy to install and effective sprinkler system for spraying structures and other objects with water to help protect them against outdoor fires.

In a broad aspect, the present invention provides a fire-protection sprinkler system for protecting an object against outdoor fires, said sprinkler system comprising: a first flexible hose having a first end and a second end; a first and a second fluid-conducting pipe, each having a first end and a second end, said first ends of said first and second pipes attached to, and in fluid connection with, the first and second ends of said first flexible hose respectively; a first and a second sprinkler head mounted on, and in fluid connection with, the second ends of said first and second pipes respectively, each of said first and second sprinkler heads having a spray axis; lateral stabilizers mounted on the sprinkler system for stabilizing the sprinkler system; and a pressurizable fire-suppression fluid source connected to the sprinkler system, and in fluid connection therewith, wherein the first flexible hose allows the first and second pipes to be positioned on the object at any of a plurality of angles to each other, the lateral stabilizers and the first and second pipes assist in maintaining the first and second sprinkler heads in position during operation, and upon pressurizing the fluid source, the fire-suppression fluid travels through the sprinkler system to the first and second sprinkler heads, which spray the fire-suppression fluid onto the object.

### BRIEF DESCRIPTION OF THE DRAWINGS

Preferred embodiments of the invention will now be described with reference to the attached drawings in which:

FIG. 1 is a side view of a sprinkler system in accordance with a preferred embodiment of the present invention;

FIG. 2 is a right end view of the sprinkler system of FIG. 1;

FIG. 3 is a top view of a sprinkler system in accordance with a second embodiment of the present invention; and

FIG. 4 is a top view of a sprinkler system in accordance with a third embodiment of the present invention.

### DETAILED DESCRIPTION OF THE PREFERRED EMBODIMENTS

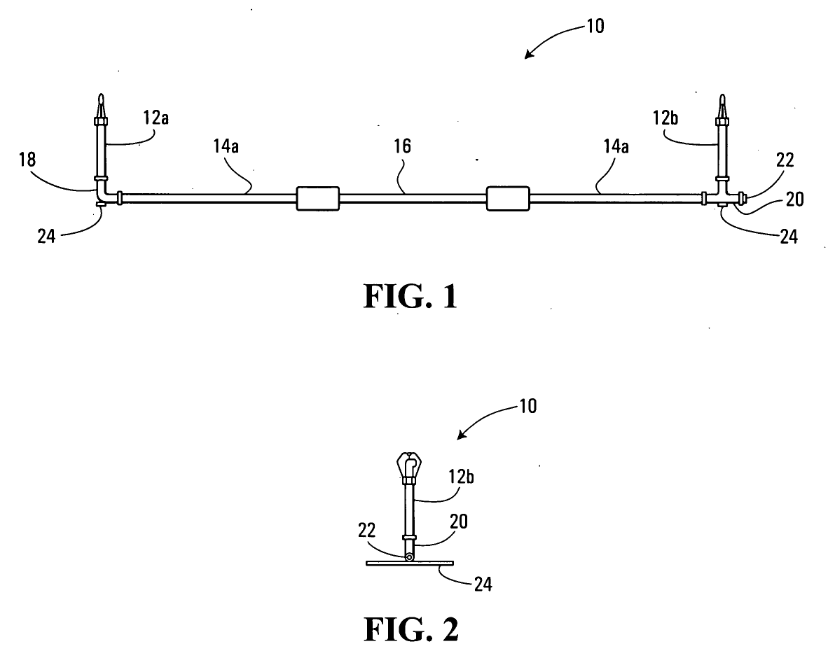

A preferred embodiment of the sprinkler system of the present invention is illustrated in FIGS. 1 and 2 and is described below in the context of an application in which the system is mounted on the roof of a building.

The basic features of the preferred embodiment sprinkler system 10 include a first and a second sprinkler head 12a, 12b affixed to a first and a second pipe 14a, 14b, which first and second pipes 14a, 14b are connected by a flexible hose 16.

The first and second sprinkler heads 12a, 12b are, in the preferred embodiment, butterfly type sprinkler heads sold for example under the trade-mark WIZ HEAD. Such butterfly type sprinkler heads are used in this preferred embodiment because they provide a uniform application of fluid which is more effective in cooling and wetting the roof of the building than are other types of sprinklers. Such sprinkler heads also have larger spray orifices reducing clogging which can result from the use of sprinkler heads having smaller spray orifices.

The first sprinkler head 12a is screw-mounted to an elbow joint 18 which is welded to one end of the first pipe 14a. The second sprinkler head 12b is screw-mounted to a stem opening of a t-junction 20 which also has two arm openings, one of the arm openings being welded to one end of the second pipe 14b.

The other ends of the first and second pipes 14a, 14b are pressure-fitted to either ends of the flexible hose 16. The first sprinkler head 12a, the elbow joint 18, the first pipe 14a, the flexible hose 16, the second pipe 14b, the t-junction 20 and the second sprinkler head 12b are all in fluid-connection with one another allowing the flow of fluid therebetween.

In this preferred embodiment, the elbow joint 18, the t-junction 20, and the first and second pipes 14a, 14b are constructed of a metal known in the industry as “black pipe”, an iron-based metal which is resistive to corrosion and is easily welded. The pipes 14a, 14b are approximately 3 feet in length and are of ½″ piping while the flexible hose 16 is a compression hose approximately 5 feet in length and of ½″ inner diameter.

Each of the elbow joint 18 and the t-junction 20 have welded thereto a stabilizing base 24 having arms extending perpendicularly to both the pipes 14a, 14b and the sprinkler heads 12a, 12b, as shown in FIG. 2. These stabilizing bases 24 act as lateral stabilizers so as to keep the sprinkler heads 12a, 12b upright during deployment and operation.

The second arm opening of the t-junction 20 has a fitting 22 connectable to a water-source hose (not shown). The water-source hose is connected to a water source, whether a municipal water system, a pump drawing water from a lake, or any other water source capable of providing water at pressure through the water-source hose.

A manner in which the above-described preferred embodiment sprinkler system 10 may be used will now be described.

The preferred embodiment sprinkler system 10 may be deployed on the roof of the building on a permanent basis, or on a temporary basis when the risk of fire is high, for example where a forest fire is approaching the building.

Deployment of the sprinkler system 10 of the preferred embodiment may be performed using either of two methods.

First, the sprinkler system 10 may be carried up on to the roof using a ladder or other ascension device and placed onto the roof. The sprinkler system 10 is preferably positioned such that the sprinkler heads 12a, 12b provide the greatest coverage to the roof, or at least to the portion of the roof where greatest fire protection is desired. On a typical single-peaked roof, the sprinkler system 10 is positioned with the flexible hose 16 draped over the peak of the roof with the two pipes 14a, 14b extending down either side from the peak. The sprinkler heads 12a, 12b are thereby positioned at some point, preferably halfway down each side of the peak. The combined effects of the pipes 14a, 14b, and the stabilizing bases 24 maintain the sprinkler heads 12a, 12b perpendicular to a local surface of the roof, namely that surface immediately surrounding the relevant sprinkler head, thereby providing the greatest possible coverage to the roof. The flexibility of the flexible hose 16 allows the sprinkler system 10 to be placed on roofs of varying shapes including those having high-angle peaks, low-angle peaks, or on flat roofs.

The water-source hose is then connected to the fitting 22 of the t-junction 20 by any of a number of known means including screw-mounting. Once water pressure in the water-source hose is provided, water travels through the t-junction 20 to the second sprinkler head 12b, and through the t-junction 20, second pipe 14b, flexible hose 16, first pipe 14a and elbow joint 18 to the first sprinkler head 12a. The sprinkler heads 12a, 12b then begin spraying water onto the roof. Preferably a uniform spray is provided by the sprinkler, thereby maximizing the cooling and wetting effect of the spray to optimize the fire-retardant effect thereof.

The second method of deploying the sprinkler system 10 of the preferred embodiment is to first throw an end of a rope over the roof from a first side of the building to the other side such that the rope will be approximately in line with the desired final orientation of the sprinkler system 10. The end of the rope is then tied to the first sprinkler head 12a, the elbow joint 18 or the first pipe 14a, and a water-source hose is connected to the fitting 22 of the t-junction 20. The rope is then pulled from the first side of the building thereby drawing the sprinkler system 10 up to the roof, and then on to the roof. The rope continues to be pulled until the sprinkler system 10 is in its desired position. Adjustments may be made to the position or orientation of the sprinkler system 10 by pulling on the rope and/or the water-source hose from the ground. The advantage of this method is that there is no necessity for personnel installing the sprinkler system 10 to climb ladders or to otherwise mount the roof of the building.

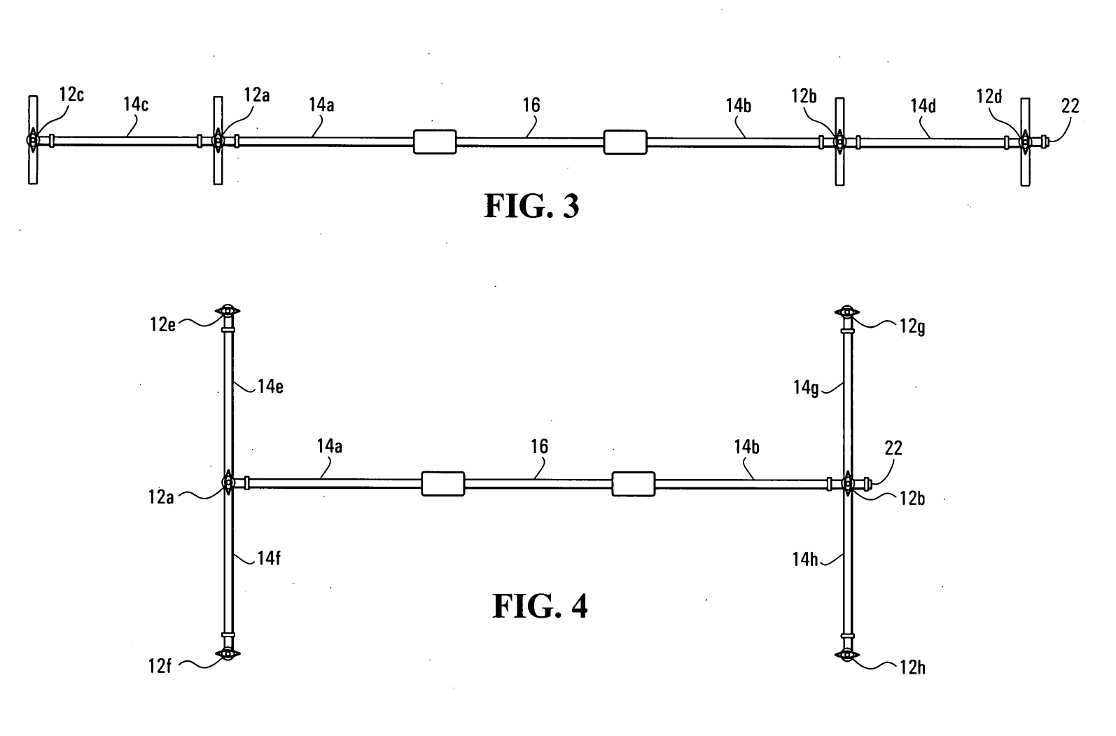

Optionally, if greater coverage of the roof is desired, additional lengths of pipe may be connected to the sprinkler system with additional sprinkler heads attached thereto. Two possible configurations are illustrated in FIGS. 3 and 4 which provide top views of a second and third embodiment of the sprinkler system of the present invention. In FIG. 3, additional lengths of pipe 14c and 14d are provided extending from, and colinear with, the first and second pipes 14a and 14b, with additional sprinkler heads 12c and 12d provided at their ends. Such a configuration allows greater coverage over a very wide roof. In FIG. 4, four additional pipes 14e, 14f, 14g, 14h are provided extending from, and perpendicular to, the first and second pipes 14a and 14b, with additional sprinkler heads 12e, 12f, 12g, 12h provided at their ends. Such a configuration allows greater coverage over a very long roof.

Additionally, greater coverage by the sprinkler heads 12a, 12b may be achieved by inserting a riser (not shown) between the first sprinkler head 12a and the elbow joint 18, and between the second sprinkler head 12b and the t-junction 20. Such risers allow the sprinkler heads 12a, 12b to be positioned further away from the roof, thereby increasing the range of the sprinkler heads 12a, 12b and also resulting in a more uniform spray falling on to the roof. In one example, a 4-inch riser may be used.

Although the sprinkler heads 12a, 12b in the preferred embodiment have been described as being butterfly-style, it is to be understood that other types of sprinkler heads may be used within the broad scope of the invention, for example impulse-type, pop-up type, spot type or oscillating.

Although the elbow joint 18, the t-junction 20 and the first and second pipes 14a, 14b have been described in the preferred embodiment as being made of black pipe, it is to be understood that these elements may be made of other materials within the broad scope of the invention, PVC, aluminum, galvanized steel or stainless steel for example.

Although the sprinkler heads 12a, 12b have been described as being connected to the elbow joint 18 and the t-junction 20 through screw-threading in the preferred embodiment, it is to be understood that these connections may be made through other means within the broad scope of the invention, glue, clamping, or pressure-fitting for example. Further, although the pipes 14a, 14b, the elbow joint 18, the t-junction 20 and the bases 24 are described as being connected by welding in the preferred embodiment, it is to be understood that these connections may be made through other means within the broad scope of the invention, screw-threading, glue, clamping or pressure-fitting for example, as appropriate. Alternatively, two or more of these elements may be integral with each other. Additionally, although the flexible hose 16 is described as being connected to the pipes 14a, 14b by a pressure-fitting in the preferred embodiment, it is to be understood that these connections may be made through other means within the broad scope of the invention, screw-threading, glue, welding or clamping for example.

Although the dimensions of the pipes 14a, 14b and flexible hose 16 have been provided in describing the preferred embodiment, it is to be understood that pipes and hoses of other dimensions may be used within the broad scope of this invention. Appropriate dimensions to be used in a particular application will be readily understood by persons skilled in the art dependent upon the size and shape of the roof, volume and pressure of water to be sprayed, etc.

Although the preferred embodiment sprinkler system has been described as being used on the roof of a building, it is to be understood that the invention may be used to protect other objects and structures against outdoor fires, bridges and lumber piles for example.

Although the preferred embodiment sprinkler system has been described with the water-source hose being connected to the t-junction 20, it is to be understood that the water-source hose may be connected to other points in the sprinkler system, the pipes 14a, 14b, or the flexible hose 16 for example, by means of appropriate connections.

Although the lateral stabilizers have been described in the preferred embodiment as arms extending laterally from the elbow joint 24 and the t-junction 20, it is to be understood that other lateral stabilizers may be used, lateral projections on the pipes 14a, 14b, the use of square piping as the pipes 14a, 14b, or projections extending downwardly and outwardly from the sprinkler heads 12a, 12b for example.

Although the preferred embodiment sprinkler system has been described as being adapted to spray water onto the object to be protected, it is to be understood that other fire-suppression fluids may be sprayed using the invention, Class A Fire Foam or Flame Out™ for example.

Numerous modifications and variations of the present invention are possible in light of the above teachings. It is therefore to be understood that within the scope of the appended claims, the invention may be practised otherwise than as specifically described herein.

1. A fire-protection sprinkler system for protecting an object against outdoor fires, said sprinkler system comprising:
a first flexible hose having a first end and a second end;
a first and a second fluid-conducting pipe, each having a first end and a second end, said first ends of said first and second pipes attached to, and in fluid connection with, the first and second ends of said first flexible hose, respectively;
a first and a second sprinkler head mounted on, and in fluid connection with, the second ends of said first and second pipes respectively, each of said first and second sprinkler heads having a spray axis;
lateral stabilizers mounted on the sprinkler system for stabilizing the first and second sprinkler heads; and
means for connecting a pressurizable fire-suppression fluid source to the sprinkler system, and in fluid connection therewith,
wherein said fire-protection sprinkler system is deployable on the object and the first flexible hose allows the first and second pipes to be positioned on the object at any of a plurality of angles relative to each other, the lateral stabilizers and the first and second pipes assist in maintaining the first and second sprinkler heads in position during operation, and upon pressurizing the fluid source, the fire-suppression fluid travels through the sprinkler system to the first and second sprinkler heads, which spray the fire-suppression fluid onto the object.

2. The sprinkler system of claim 1 wherein the first and second sprinkler heads are mounted on said first and second pipes and the lateral stabilizers are mounted on the sprinkler system in an orientation which assists in ensuring that, when the sprinkler system is placed on the object, each of the first and second sprinkler heads is maintained in a position such that its spray axis is substantially perpendicular to a local surrounding surface of the object.

3. The sprinkler system of claim 1 wherein the first and second sprinkler heads are mounted such that their spray axes are perpendicular to the first and second pipes, respectively.

4. The sprinkler system of claim 2 wherein the first and second sprinkler heads are mounted such that their spray axes are perpendicular to the first and second pipes, respectively.

5. The sprinkler system of claim 1 wherein a first lateral stabilizer extends from the sprinkler system perpendicularly to each of the spray axis of the first sprinkler head and the first pipe, while a second lateral stabilizer extends from the sprinkler system perpendicularly to each of the spray axis of the second sprinkler head and the second pipe.

6. The sprinkler system of claim 2 wherein a first lateral stabilizer extends from the sprinkler system perpendicularly to each of the spray axis of the first sprinkler head and the first pipe, while a second lateral stabilizer extends from the sprinkler system perpendicularly to each of the spray axis of the second sprinkler head and the second pipe.

7. The sprinkler system of claim 3 wherein a first lateral stabilizer extends from the sprinkler system perpendicularly to each of the spray axis of the first sprinkler head and the first pipe, while a second lateral stabilizer extends from the sprinkler system perpendicularly to each of the spray axis of the second sprinkler head and the second pipe.

8. The sprinkler system of claim 4 wherein a first lateral stabilizer extends from the sprinkler system perpendicularly to each of the spray axis of the first sprinkler head and the first pipe, while a second lateral stabilizer extends from the sprinkler system perpendicularly to each of the spray axis of the second sprinkler head and the second pipe.

9. The sprinkler system of claim 5 wherein the first sprinkler head is mounted to the first pipe using an elbow joint.

10. The sprinkler system of claim 9 wherein the second sprinkler head is mounted to the second pipe using a t-junction.

11. The sprinkler system of claim 10 wherein the first lateral stabilizer is mounted to the elbow joint and the second lateral stabilizer is mounted to the t-junction.

12. The sprinkler system of claim 10 wherein the means for connecting a pressurizable fire-suppression fluid source includes a fitting connected to the sprinkler system at the t-junction.

13. The sprinkler system of claim 1 wherein the sprinkler system further comprises a third pipe and a fourth pipe, each having a first end and a second end, said first ends of said third and fourth pipes, attached to, and in fluid connection with, the first and second pipes, respectively, and the system further comprising third and fourth sprinkler heads mounted on, and in fluid connection with, the second ends of said third and fourth pipes, respectively.

14. The sprinkler system of claim 13 wherein the third pipe is substantially colinear with the first pipe and the fourth pipe is substantially colinear with the second pipe.

15. The sprinkler system of claim 13 further comprising a fifth pipe and a sixth pipe, each having a first end and a second end, said first ends of said fifth and sixth pipes attached to, and in fluid connection with, the first and second pipes, respectively, said system further comprising fifth and sixth sprinkler heads being mounted on, and in fluid connection with, the second ends of said fifth and sixth pipes, respectively.

16. The sprinkler system of claim 15 wherein the third and fifth pipes are substantially perpendicular to the first pipe and substantially colinear with each other, and the fourth and sixth pipes are substantially perpendicular to the second pipe and substantially colinear with each other.

17. (canceled)

18. The sprinkler system of claim 1 wherein the first and second sprinkler heads are butterfly sprinkler heads.

19. The sprinkler system of claim 1 wherein the first and second pipes are made of black pipe.

20. The sprinkler system of claim 1 wherein the inner diameters of the first and second pipes are about one half of an inch.
